(19) United States
(12) Patent Application Publication
(10) Pub. No.: US 2010/0072874 A1
(43) Pub. Date: Mar. 25, 2010

(54) SPARK PLUG

(76) Inventor: Chen-Chun Liao, Tainan County (TW)

Correspondence Address: BERENATO & WHITE, LLC, 6550 ROCK SPRING DRIVE, SUITE 240, BETHESDA, MD, 20817, US

(21) Appl. No.: 12/482,491

(22) Filed: Jun. 11, 2009

(30) Foreign Application Priority Data
Jun. 26, 2008 (TW) 097123883

(51) Int. Cl. H01T 13/32

(52) U.S. Cl. 313/139

(57) ABSTRACT

A spark plug includes a ceramic insulator sleeved on a center electrode so that an end of the center electrode extends outwardly of an end surface of the ceramic insulator, a conductive outer shell surrounding spacedly the ceramic insulator, and a ground electrode including an annular portion disposed coaxially around the end of the center electrode such that an annular gap smaller than 1 mm is defined between the annular portion and the ceramic insulator, and a connecting portion interconnecting electrically the annular portion and the conductive shell. The annular portion of the ground electrode cooperates with the end of the center electrode and the end surface of the ceramic insulator to define an air-blocking space thereamong in spatial communication with the annular gap.

### CROSS-REFERENCE TO RELATED APPLICATION

This application claims priority of Taiwanese Application No. 097123883, filed on Jun. 26, 2008.

### BACKGROUND OF THE INVENTION

1. Field of the Invention

The invention relates to a spark plug, more particularly to a spark plug for internal combustion engines.

2. Description of the Related Art

FIG. 1 illustrates a conventional spark plug 1 for an internal combustion engine that includes a center electrode 12 held by a ceramic insulator 11 and having an end exposed outwardly of the ceramic insulator 11, a housing 13 surrounding spacedly the ceramic insulator 11, and a ground electrode 14 disposed at an upper end of the housing 13. When a high voltage is applied to the conventional spark plug 1, the center electrode 12 discharges to generate a discharge spark between the center electrode 12 and the ground electrode 14. As a result, combustion in a combustion chamber (not shown) of the internal combustion engine is ignited by the discharge spark.

However, in such a configuration, since the center electrode 12 has a relatively small discharge area, the conventional spark plug 1 results in inferior combustion efficiency of the combustion chamber. Furthermore, after a period of use, since carbonized contaminants are easily accumulated on the center electrode 12 and the ground electrode 14, short circuit between the center and ground electrodes 12, 14 cannot be avoided.

### SUMMARY OF THE INVENTION

Therefore, an object of the present invention is to provide a spark plug that can overcome the aforesaid drawbacks of the prior art.

According to the present invention, a spark plug comprises:

a center electrode extending along an axis;

a ceramic insulator sleeved on the center electrode so that an end of the center electrode extends outwardly of an end surface of the ceramic insulator;

a conductive outer shell surrounding spacedly the ceramic insulator; and

a ground electrode including an annular portion disposed coaxially around the end of the center electrode such that an annular gap is defined between the annular portion and the ceramic insulator, and at least one connecting portion interconnecting electrically the annular portion and the conductive shell, the annular gap being smaller than 1 mm.

The annular portion of the ground electrode cooperates with the end of the center electrode and the end surface of the ceramic insulator to define an air-blocking space thereamong, the air-blocking space being in spatial communication with the annular gap.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional spark plug;

FIG. 2 is a perspective view showing the first preferred embodiment of a spark plug according to the present invention;

FIG. 3 is a fragmentary enlarged perspective view showing the first preferred embodiment;

FIG. 4 is a fragmentary schematic sectional view showing the first preferred embodiment;

FIG. 5 is a schematic top view showing the first preferred embodiment;

FIG. 6 is a fragmentary schematic sectional view showing the second preferred embodiment of a spark plug according to the present invention; and

FIG. 7 is a perspective view showing the third preferred embodiment of a spark plug according to the present invention.

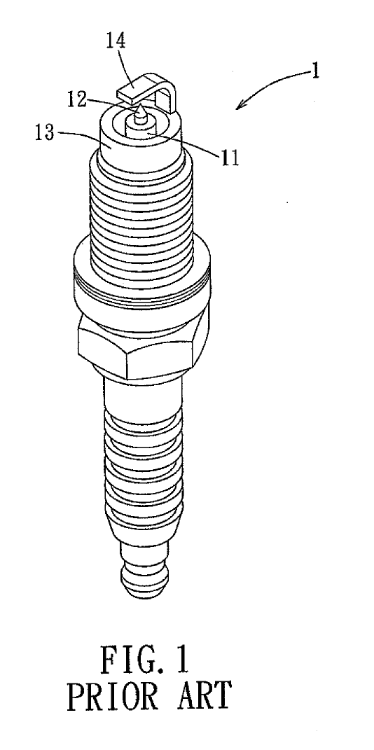

### DETAILED DESCRIPTION OF THE PREFERRED EMBODIMENTS

Before the present invention is described in greater detail, it should be noted that like elements are denoted by the same reference numerals throughout the disclosure.

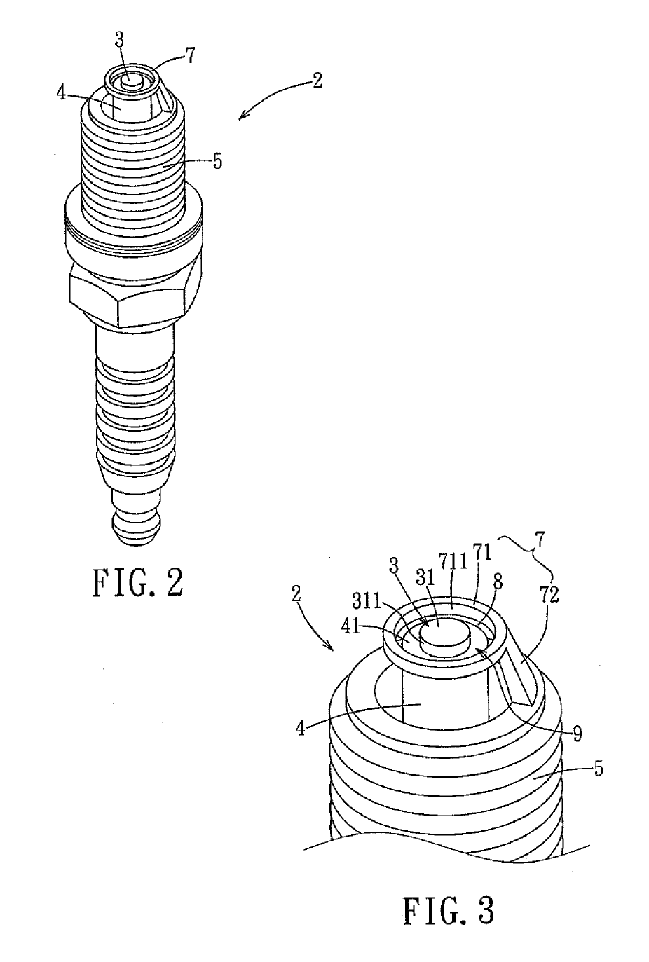

Referring to FIGS. 2 to 4, the first preferred embodiment of a spark plug 2 for an internal combustion engine according to the present invention is shown to include a center electrode 3, a ceramic insulator 4, a conductive outer shell 5, and a ground electrode 7.

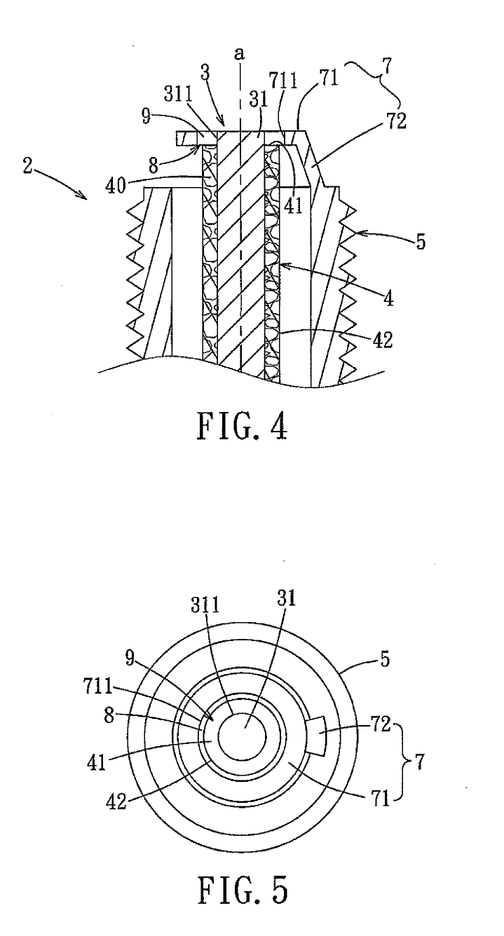

The center electrode 3 is cylindrical and extends along an axis (a), as shown in FIG. 4.

The ceramic insulator 4 is sleeved on the center electrode 3 so that an end 31 of the center electrode 3 extends outwardly of an end surface 41 of the ceramic insulator 4.

The outer shell 5 surrounds spacedly the ceramic insulator 4. In this embodiment, the ceramic insulator 4 has an end portion 40 with the end surface 41 exposed outwardly of the outer shell 5.

The ground electrode 7 includes an annular portion 71 and a connecting portion 72. The annular portion 71 is disposed coaxially around the end 31 of the center electrode 3 so that an annular gap 8 is defined between the annular portion 71 and the ceramic insulator 4. The connecting portion 72 interconnects electrically the annular portion 71 and the outer shell 5. The annular gap 8 is smaller than 1 mm. In this embodiment, the annular portion 71 of the ground electrode 7 has an inner diameter that is larger than an outer diameter of the ceramic insulator 4. The annular gap 8 is disposed between an inner surface 711 of the annular portion 71 of the ground electrode 7 and an outer surface 42 of the ceramic insulator 4, as best shown in FIGS. 4 and 5.

The annular portion 71 of the ground electrode 7 cooperates with the end 31 of the center electrode 3 and the end surface 41 of the ceramic insulator 4 to define an air-blocking space 9 thereamong. The air-blocking space 9 is in spatial communication with the annular gap 8.

In such a configuration, an outer surface 311 of the end 31 of the center electrode 3 serves as a spark discharging surface. The inner surface 711 of the annular portion 71 of the ground electrode 7 faces the outer surface 311 of the end 31 of the center electrode 3, and serves as a spark landing surface. Since the spark discharging surface and the spark landing surface have relatively large areas as compared to those of the aforesaid conventional spark plug 1, more discharge sparks are generated between the spark discharging surface and the spark landing surface, thereby resulting in high-efficiency combustion ignited by the discharge sparks. As a result, performance of the internal combustion engine is enhanced, and pollution is reduced.

Furthermore, in use, fuel in the air-blocking spaces 9 flows in a high speed through the annular gap 8 as a result of high-pressure compression by a piston (not shown), carbonized contaminants are hardly accumulated on the end 31 of the center electrode 3 and the annular portion 71 of the ground electrode 7. Therefore, short-circuit problem as encountered in the prior art can be avoided.

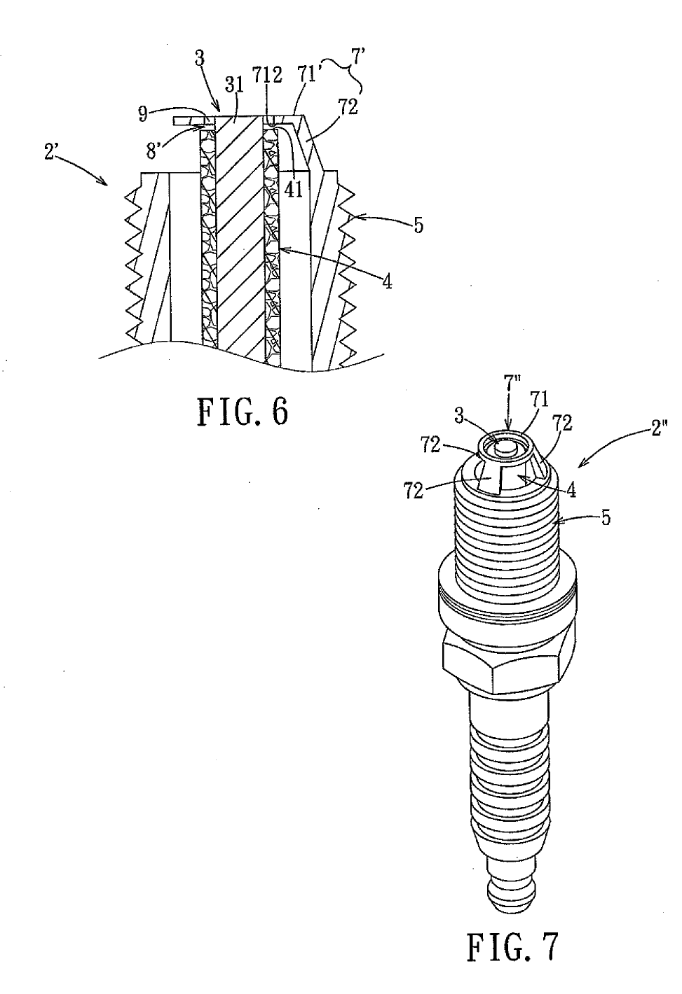

FIG. 6 illustrates the second preferred embodiment of a spark plug 2′ according to this invention, which is a modification of the first preferred embodiment.

In this embodiment, the annular portion 71′ of the ground electrode 7′ has an inner diameter that is smaller than an outer diameter of the ceramic insulator 4, and a side surface 712 opposite to the end surface 41 of the ceramic insulator 4.

It is noted that the annular gap 8′ is disposed between the side surface 712 of the annular portion 71′ of the ground electrode 7′ and the end surface 41 the ceramic insulator 4.

FIG. 7 illustrates the third preferred embodiment of a spark plug 2″ according to this invention, which is modification of the first preferred embodiment.

Unlike the first preferred embodiment, the ground electrode 7″ includes the annular portion 71, and three of the connecting portions 72 that are angularly equidistant in this embodiment.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A spark plug comprising:
a center electrode extending along an axis;
a ceramic insulator sleeved on said center electrode so that an end of said center electrode extends outwardly of an end surface of said ceramic insulator;
a conductive outer shell surrounding spacedly said ceramic insulator; and
a ground electrode including an annular portion disposed coaxially around said end of said center electrode such that an annular gap is defined between said annular portion and said ceramic insulator, and at least one connecting portion interconnecting electrically said annular portion and said conductive shell, said annular gap being smaller than 1 mm;
wherein said annular portion of said ground electrode cooperates with said end of said center electrode and said end surface of said ceramic insulator to define an air-blocking space thereamong, said air-blocking space being in spatial communication with said annular gap.

2. The spark plug as claimed in claim 1, wherein:
said annular portion of said ground electrode has an inner diameter that is larger than an outer diameter of said ceramic insulator; and
said annular gap is disposed between an inner surface of said annular portion of said ground electrode and an outer surface of said ceramic insulator.

3. The spark plug as claimed in claim 1, wherein:
said annular portion of said ground electrode has an inner diameter that is smaller than an outer diameter of said ceramic insulator, and a side surface opposite to said end surface of said ceramic insulator; and
said annular gap is disposed between said side surface of said annular portion of said ground electrode and said end surface of said ceramic insulator.

4. The spark plug as claimed in claim 1, wherein said ceramic insulator has an end portion with said end surface exposed outwardly of said outer shell.

5. The spark plug as claimed in claim 1, wherein said ground electrode includes a plurality of said connecting portions.
